(19) United States
(12) Patent Application Publication
(10) Pub. No.: US 2011/0101646 A1
(43) Pub. Date: May 5, 2011

(54) Vehicle equipped with coupler

(76) Inventor: Masami Sakita, San Francisco, CA (US)

(21) Appl. No.: 12/799,140

(22) Filed: Apr. 19, 2010

Related U.S. Application Data
(63) Continuation-in-part of application No. 12/589,924, filed on Oct. 30, 2009.

(51) Int. Cl. B60D 1/40; B60D 1/42

(52) U.S. Cl. 280/479.1; 280/478.1

(57) ABSTRACT

The vehicle operated on highways and streets of the present invention includes a front coupler and a rear coupler, at least one on-board computer, a lateral location sensor, at least one lateral location sensor guidance means, a lateral position control means, a longitudinal sensor, a longitudinal position control means, a GPS coordinates receiver, a display unit, and at least one communication means. The coupler includes a pair of retractable snubber assemblies and a pair of coupling means. The coupling means is affixed to the outer end of the coupler by springs, and movable in the lateral, longitudinal and vertical directions.

### RELATED APPLICATION

This is a continuation-in-part of a co-pending application Ser. No. 12/589,924 entitled “Vehicle Operated on Electric Highway” filed on Oct. 30, 2009.

### FIELD OF THE INVENTION

This invention relates generally to vehicles that are equipped with couplers and operated on highways and city streets.

### BACKGROUND OF THE INVENTION

In the co-pending application Ser. No. 12/589,925, the inventor of the present invention described a vehicle operated on the electric highway. The vehicle operated on the electric highway is equipped with at least one coupler for physically coupling vehicles, lateral and longitudinal sensors and lateral and longitudinal position control means that enable automatic operation of coupled vehicles in the electrified lane equipped with a wayside lateral location control guidance means. The preferred embodiment of the vehicle proposed in application Ser. No. 12/589,925 includes a snubber type coupler equipped with a magnetic coupling means in the preferred embodiment.

The idea of automatically operating coupled vehicles is an extension of the idea of the automated platoon operation of vehicles demonstrated in the real-world experiments by the PATH (California Partners for Advanced Transit and Highways administered by the Institute of Transportation Studies at the University of California at Berkeley in cooperation with Caltrans) in cooperation with General Motors and its various subsidiaries in 1997. In these experiments the PATH researchers found that vehicles traveling in a tight, automated platoon with about half a vehicle interval have a dramatic reduction in aerodynamic drag that results in a 20 to 25-percent improvement in fuel economy and emission reduction.

Operating a string of coupled vehicles on ordinary highways should also be able to achieve similar effects in terms of improvements in energy use as in those electric vehicles operated in the electrified lane. Coupled operation should also lead to a few times higher capacity per lane, and this higher capacity in turn should lead to less or no congestion on highways and less need for construction of new highways, and should also greatly increase the signalized intersection capacity of the city streets.

### OBJECTS OF THE INVENTION

An object of this invention is the provision of a vehicle that is able to operate, while being coupled with other vehicles on ordinary highways or city streets not equipped with wayside lateral location sensor guidance means, and on automated highways or city streets equipped with wayside lateral location sensor guidance means.

### SUMMARY OF THE INVENTION

The preferred embodiment of the vehicle operated on highways and streets of the present invention includes a front coupler and a rear coupler, at least one on-board computer, a lateral location sensor, at least one lateral location sensor guidance means, a lateral position control means, a longitudinal sensor, a longitudinal position control means, a GPS coordinates receiver, a display unit, and at least one communication means.

The lateral location sensor uses at least one pair of magnetometers affixed to generally the front end of the vehicle symmetrically arranged about the vehicle's center point of the front end and faced generally forward. At least one lateral location sensor guidance means is attached to generally the rear end of the vehicle in such a manner that the magnetic field (or fields) generated will be generally symmetric about the center of the rear end of the vehicle. The lateral location sensor senses the strength of magnetic fields generated by the on-board lateral location sensor guidance means attached to another vehicle that operates in front of the present vehicle.

The coupler is retractable when it is not in use, and includes a pair of snubber assemblies each of which assemblies includes a coupling means. The coupling means of two vehicles use magnetic force to couple together. The purpose of the coupler is not to pull following vehicles, and thus the magnetic force created by the coupler does not have to be strong enough to pull the following vehicle. The coupler is designed to absorb most of the longitudinal, lateral and vertical dislocations between the coupled vehicles during normal driving within the highway or street lane. In the vehicles running in a platoon that are already coupled together, the worst can happen is that a following vehicle (or vehicles) will push a vehicle (or vehicles) ahead.

### BRIEF DESCRIPTION OF THE DRAWINGS

The above description and other objects and advantages of this invention will become more clearly understood from the following description when considered with the accompanying drawings. It should be understood that the drawings are for purposes of illustration only and not by way of limitation of the invention. In the drawings, like reference characters refer to the same parts in the several views:

FIG. 1 is a schematic cross-sectional view of the preferred embodiment of the vehicle of the present invention;

FIG. 2 is a schematic bottom view of the preferred embodiment of the vehicle of the present invention in a highway lane that is equipped with wayside lateral location sensor guidance means;

FIG. 3A is a cross-sectional view of a front coupler in the contracted state, and 3B a cross-sectional view of the front coupler in the expanded state;

FIG. 4A is a front view and FIG. 4B a cross-sectional view of the front coupler and a cross-sectional view of the coupling means of the rear coupler;

FIG. 5A is a front view, 5B a side view, 5C a bottom view in the retracted state and 5D in the extended state of a coupler of an alternative embodiment; and

FIG. 6A is a cross-sectional view of the couplers of an alternative embodiment of two vehicles before coupling, 6B while in the coupled state, and 6C after the following vehicle has taken decoupling action.

### DETAILED DESCRIPTION OF THE INVENTION

### Preferred Embodiment

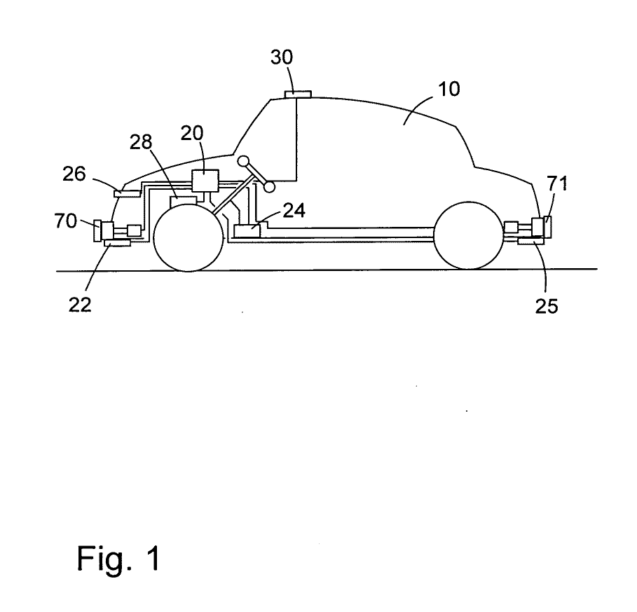

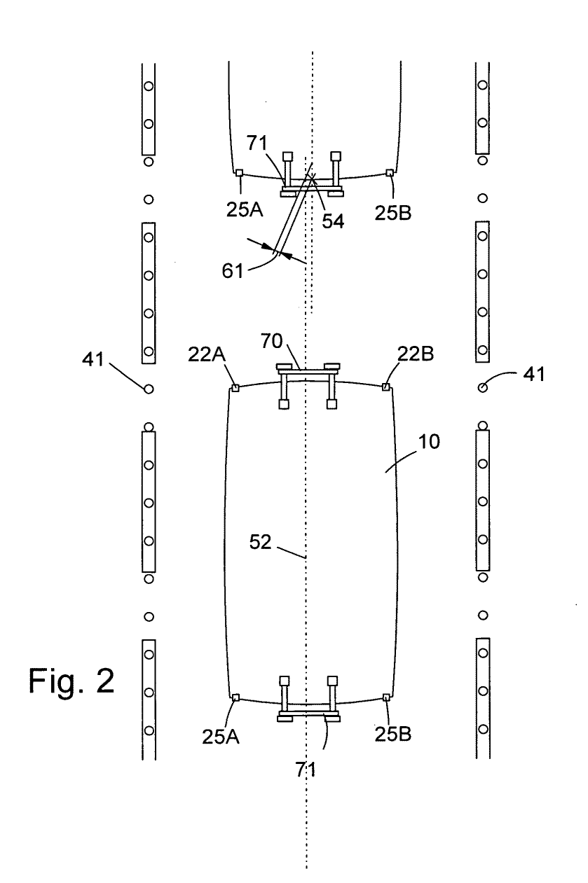

As shown in FIGS. 1 and 2 of the drawings, the preferred embodiment 10 of the vehicle operated on highways and streets of the present invention includes a front coupler 70 and a rear coupler 71, at least one on-board computer 20, a lateral location sensor 22, at least one lateral location sensor guidance means 25, a lateral position control means 24, a longitudinal sensor 26, a longitudinal position control means 28, a GPS coordinates receiver, a display unit, and at least one communication means 30. As shown in FIG. 1, the lateral/longitudinal sensors and control devices, and the couplers are connected to the on-board computer 20 by wires.

The lateral location sensor 22 includes at least one pair of magnetometers 22A and 22B affixed to generally the front end of the vehicle symmetrically arranged about the vehicle's center at the front end. At least one lateral location sensor guidance means 25 is attached to generally the rear end of the vehicle 10 in such a manner that the magnetic field generated is (or fields generated are) generally symmetric about the center of the rear end of the vehicle. The lateral location sensor 22 measures the strength of magnetic fields generated by the lateral location sensor guidance means 25 of another vehicle that is running ahead of the present vehicle in ordinary highways or streets that are not equipped with the wayside lateral location sensor guidance means. The magnetic field generator 25A (and 25B) may be a permanent magnet, or a means that uses electricity to generate a magnetic field (see FIG. 2).

When the present vehicle is following a leading vehicle in a close distance, the lateral location sensor 22 is designed to estimate the amount of deviation 61 of the lateral center line 52 of the present vehicle from the center point 54 of the leading vehicle at generally the rear end of the leading vehicle, wherein the estimation of deviation is based on observed correlation between the normalized difference of the strengths of the magnetic fields observed by at least one pair of the magnetometers and actual deviation of the extension of the center line of the present vehicle from the center point of the rear end of the leading vehicle.

The same lateral location sensor 22 will be also used to estimate the deviation of the center of the vehicle from the center line of a highway lane that is equipped with wayside lateral location sensor guidance means 41 that comprises serially arranged permanent magnet cells buried along the lane markings on each side of the lane in which the vehicle 10 operates (see FIG. 2). The on-board lateral location sensor guidance means 25 that electrically generate a magnetic field (or magnetic fields) can be shut off or shielded when the vehicle 10 travels in a highway segment that is equipped with the wayside lateral location sensor guidance means.

The lateral position control means 24 includes a computer-controlled motor to rotate the steering wheel shaft. The lateral position control means 24 should be able to steer the vehicle in such a manner that the centerline 52 of the vehicle at the front end will generally coincide with the center point 54 of the rear end of the leading vehicle when solely the on-board lateral location sensor guidance means 25 is utilized. While in the highway or street lane equipped with the wayside lateral location sensor guidance means 41, the on-board computer 20 computes the amount of rotational angle the motor should make based on the estimated deviation of the front center point of the vehicle from the imaginary center line of the highway or street lane in which the vehicle is running.

The longitudinal sensor 26 is mounted in a front part of the vehicle. It measures the distance and the speed difference between the present vehicle and the vehicle ahead of it. The longitudinal sensor 26 will be a radar that emits electromagnetic waves forward and measures the time it takes in reflecting back from the leading vehicle and changes made in the waves in the process. Using the distance and the relative speed information, the on-board computer 20 determines the acceleration/deceleration rate. The longitudinal position control means 28, which is an electro-mechanical device that executes acceleration and braking control of the vehicle as ordered by the on-board computer.

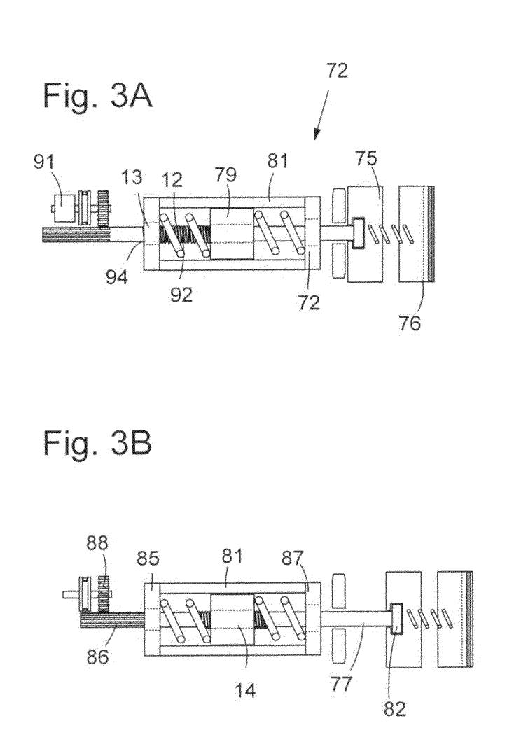

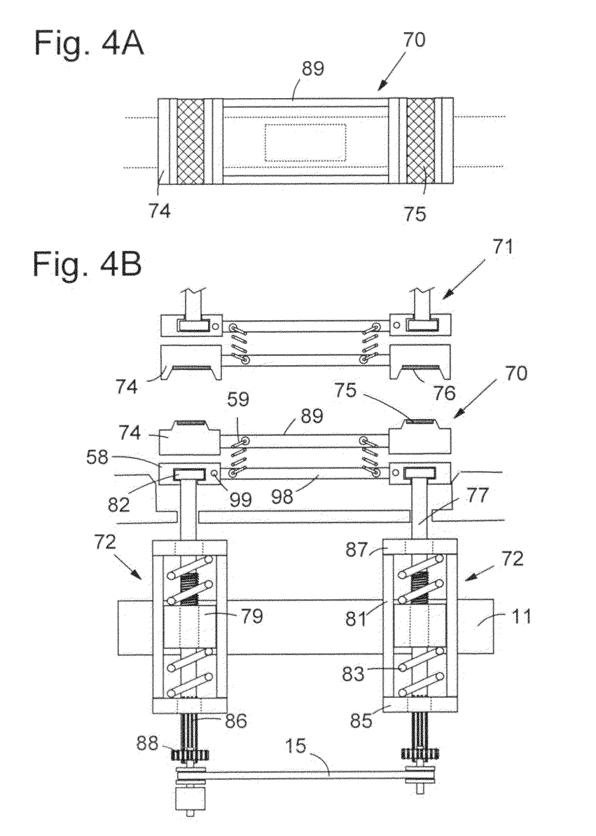

The front coupler 70 includes a pair of snubber assemblies 72 each of which assemblies includes a rotatably-slidable cylindrical boss 82 affixed to an outer end of the snubber rod 77 enclosed in a socket 58 that is connected together to each other by an inner connecting bar 98 and pins 99. A pair of coupling means 74 with a protruded contact surface 75 that is connected to each other by an outer connecting means 89 and faces the forward direction is disposed in front of the inner connecting means 98 and connected to the inner connecting means 98 by a plurality of springs 59 (see FIGS. 3A, 3B, 4A and 4B).

The outer wall of the longitudinal middle part of the snubber rod 77 has external threads 12 that mesh with internal threads 13 of an internal end wall 85 of the snubber assembly 72 under the contracted state of the snubber assembly 72. The external threads 12 of the snubber rod 77 mesh with internal threads of a bearing 79, which is slidably received by a cylindrical housing 81 of the snubber assembly 72 that is affixed to the frame 11 of the vehicle 10.

Longitudinal movement of the bearing is restricted by a pair of coil springs 83 each of which is disposed between the outer end wall 87 (front wall in the front coupler) of the snubber 72 and the front end of the bearing 79, or between the rear end of the bearing 79 and the inner end wall 85 (rear wall in the front coupler) of the snubber 72. The outer end wall 87 has a cylindrical hole through which the snubber rod 77 slidably penetrates.

The snubber rod 77 has gear teeth 86 on the outer cylindrical wall in the inner end. The gear teeth 86 of the snubber rod meshes with a gear 88 that is affixed to or rotatably connected to the rotational shaft of a motor 91. The snubber rods 77 of the pair of snubber assemblies are rotatably connected by pulleys and belt 15. As the motor 91 rotate, the coupler extends, and the thread 92 of the snubber rod's outer wall finish meshing with the internal thread 94 of the inner end wall of the snubber, and thus under the extended state, the snubber rod is solely supported by the bearing through meshing of the threads.

The rear coupler 71 is identical to the front coupler 70 except that the coupling means 74 of the rear coupler 71 is facing backward, and its coupling means 74 has a concave lateral cross-section and a contact surface 76 is attached to the receded part to which the contact surface 75 of the coupling means 74 of the front coupler 70 is docked while the couplers 70 and 71 are coupled together. Under the coupled state, both of the snubber rods 77 of the front coupler 70 and the rear coupler 71 are extended. Under the extended state of the coupler, the coupling means are movable longitudinally, laterally and vertically as much as the springs 59 and 83 allow.

The contact surfaces 74 and 75 are magnetized electrically under the coupled state, wherein the magnetic poles of the coupling means 74 and 75 are made opposite to each other so that the coupling means of the front and rear couplers will attract each other. The magnetic pole will be reversed by the vehicle that decides to decouple from the other vehicle. The coupling means may be replaced by a suction cup connected to an air compressor or other materials such as Velcro. Alternatively, the rear coupler may be of such a design that is equipped only with the coupling means affixed to the body of the vehicle directly.

The coupler will have three “to-be-standardized” coupler heights and sizes: the highest and largest coupler for large trucks and buses, the medium height and medium size coupler for SUVs and medium size trucks, and the lowest and smallest coupler for passenger cars. Alternatively, at least the car, the SUV and the medium size truck may use the same coupler height and size so that they can couple together.

Coupling of vehicles are done (1) in the highway lane or in the street lane while the present vehicle is following a vehicle equipped with the couplers, or in the street lane as the present vehicle caught up with a leading vehicle at the intersection, or (2) in the off-street space such as that used for park-and-ride or truck stops. If the coupling is done as in (1) above, the coupling will be disengaged as soon as the leading/following vehicle overtly changes its direction or switches on a turning signal, where “overtly changes its direction” means that the lateral location sensor has sensed that the leading/following vehicle has “overtly is changing its direction” as the leading/following vehicle has started to change lanes or started to make turning maneuvers. If a force in any direction including changing directions by either vehicle is applied to the couplers, the couplers will disengage also.

When the coupling is done as in (2) above, the GPS coordinates reading indicates that the vehicle has coupled outside the highway lanes, and the drivers can suppress the automatic disengagement function as long as the coupling will be kept less than a given speed, for example, 30 mph even if the leading vehicle changes its direction. In a similar manner the coupling is dissolved if the following vehicle abruptly slows down and its reduced speed is recognized by the longitudinal sensor.

The communication means 30 will send GPS coordinates so that the driver and the computer of nearby vehicles equipped with the couplers will be able to recognize where other vehicles equipped with the couplers 70 and 71 are located at. If the driver of the vehicle wants the vehicle to be non-couplable, he/she presses “Non-Couplable” button on the dashboard of the vehicle, then the status indicator, of which default mode is “Couplable” will change to “Non-Couplable.”

When the on-board computer 20 of the vehicle 10 senses another vehicle with “Couplable” signal directly in front of it or behind, the on-board computer will activate the lateral location sensor, the longitudinal sensor 26, the on-board lateral and longitudinal position control means 24 and 28, respectively. When the distance between the present vehicle and a vehicle ahead of it in the same lane reaches the distance for the longitudinal sensor 26 to function, the longitudinal sensor of the present vehicle starts to measure the distance between the “present” vehicle and the vehicle immediately ahead (or a leading vehicle) of it continually every small time increment. If the lateral location sensor 22 is not functioning at that time, the driver will have to steer the vehicle until the lateral location sensor becomes activated, and the status is shown on the display. Similarly, if the lateral location starts to function before the longitudinal sensor does, the driver must manually control the speed of the vehicle while it gives away the steering work to the lateral position control means.

If the highway or street lane is equipped with wayside lateral location sensor guidance means 41, all vehicles, including the primary leading vehicle, will be operated automatically by the on-board computer 20, the lateral position control means 24 that uses magnetic fields generated by the wayside lateral location sensor guidance means and the longitudinal position control means 28. The driver will be notified that the vehicle has entered the automated segment on the display when the vehicle enters into an automated highway or street segment that is equipped with a series of permanent magnet cells buried along the highway lane or street lane with an equal spacing in each side of the highway lane or street lane.

In the non-automated highway segment, the number of vehicles coupled together may be limited, for example, to 3, mainly because of the concern on safety. In the automated highway segment, the number of vehicles coupled together may have to be limited, for example, to 6. The main reason for this is that the larger the number (of vehicles coupled together) the larger the cumulative deviation of the couplers (from the deviation-free point) will become, and thus, at a certain point (or number of vehicles) the operation will become infeasible.

The longitudinal position control process of the “present” vehicle that is following a vehicle to which the “present” vehicle will be couplable comprises two parts: the first part begins when the vehicle enters into the catching up mode operation and ends when the vehicle is coupled with the leading vehicle. The second part begins as the vehicle is coupled with the leading vehicle, and ends when the vehicle is decoupled from the leading vehicle to leave the electrified lane.

In the first part of operation, the amount of gas or power the vehicle will use (or braking applied) for driving the engine or motor is determined in such a manner that the “present” vehicle will be able to attain a specific acceleration/deceleration rate relative to the acceleration/deceleration rate of the leading vehicle wherein the specific acceleration/deceleration rate may be expressed as a function of the leading vehicle's speed, acceleration/deceleration rate and the distance between the leading vehicle and the “present” vehicle.

Note that in any two vehicles running in series in the same lane, when a string of vehicles are running in a platoon or coupled together, the first vehicle of the string is called the primary leading vehicle.

In the coupled operation, the on-board computer of the “present” vehicle that is the last vehicle in a string of vehicles following a primary leading vehicle will adjust the amount of gas (or power) used by the engine (or the motor) in such a manner that the distance between the “present” vehicle and the primary leading vehicle will be that equals the cumulative length of the vehicles in the string of vehicles between the present vehicle and the primary leading vehicle plus the sum of the deviation-free coupler lengths of all of the vehicles in the platoon. In order to achieve this, every vehicle in the string is notified from the vehicles ahead of it the deviation-free coupler lengths and actual lengths of vehicles prior to coupling through the communication means, and the sum of the actual deviation of the couplers on an on-line real-time basis every small time increment continuously after coupling. If maintaining a constant distance between vehicles is not possible because of the lack of engine or motor power, the vehicle will have to decouple from the leading vehicle.

If the driver of a coupled vehicle in the middle of a string of vehicles wants to leave the platoon, he/she presses the “Decouple” button on the dashboard, turns the steering wheel, or presses the brake pedal. The on-board computer of the vehicle will unlock the couplers and retract them, and will transmit a “want to decouple” message to the vehicles in the group. Then, the vehicle that is immediately behind the decoupling vehicle will become the primary leading vehicle of the second half of the group of vehicles. The driver of the first vehicle of the second half of the group will have to manually drive the vehicle unless the vehicle is in an automatically operated highway segment. In the automatically operated highway segment, the vehicle is on the automatic longitudinal control, and the driver will not take any action. The following vehicle that is coupled to a leading vehicle is operated fully automatically by the on-board computer 20, the lateral position control means 24 and the longitudinal position control means 28.

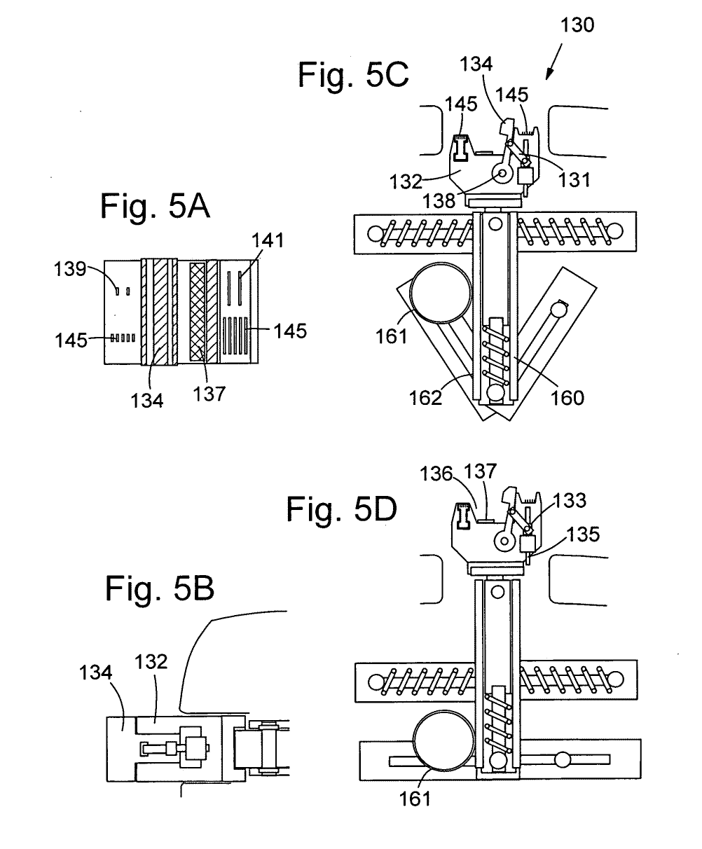

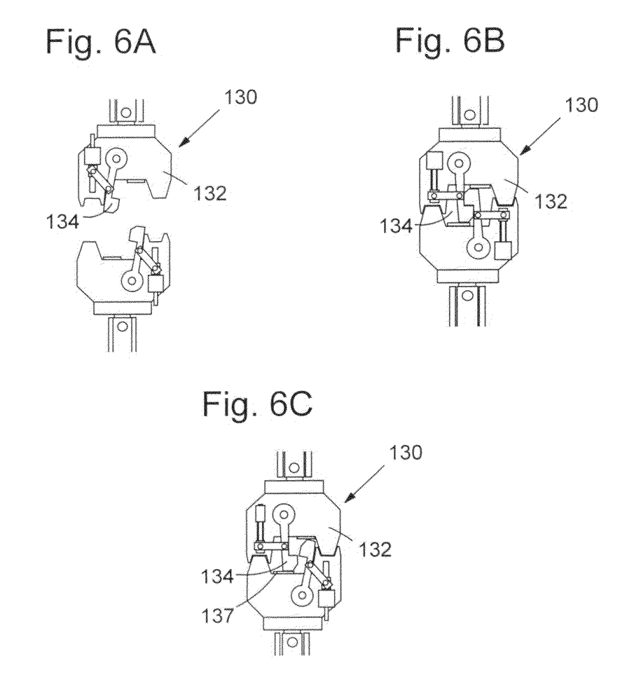

As FIGS. 5A through 5D and FIGS. 6A through 6C show, a coupler 130 of an alternative design has a mechanical coupling means. The coupler is also a retractable type having a housing 132 that encloses a coupling hook means 134 and a coupling hook receiving bay 136 disposed side by side. This coupler resembles a popular European rail coupler called Scharfenberg coupler in physical appearance. The coupling hook means 134 is narrower at the tip, and is pivotably affixed to a pin 138 and is made pivotable (or able to pivot) by a control means that includes a control arm 131 and a control rod 133. As a pneumatic actuator 135 extends and contracts the control rod 133, it pushes and pulls the control arm 131. The coupling hook receiving bay 136 is wider at the opening end for easier entry of the hook means of the coupler, and has a switch 137 at the deepest end from the opening. During the coupling process, as soon as the tip of the hook means of one coupler hits the switch, the actuator is activated and the hook means of the receiving coupler pivots toward the center of the coupler. Coupling is completed as the hook means of both couplers lock them together.

This coupler also may have the three “to-be-standardized” coupler heights and sizes as with that used in the preferred embodiment, but this coupler is most effectively used on a large long-haul trucks. The coupler is spring loaded laterally and longitudinally, and is movable in these directions within a limited range. The front surface of the coupler has connection means 139 and 141 for communication cables. The coupling means is able to slide vertically while the vehicle is coupled to another vehicle, and thus the connecting means too will be made slidable vertically.

The invention having been described in detail in accordance with the requirements of the U.S. Patent Statutes, various other changes and modifications will suggest themselves to those skilled in this art. It is intended that such changes and modifications shall fall within the spirit and scope of the invention defined in the appended claims.

1. A vehicle operated on highways including a front coupler and a rear coupler for physically coupling said vehicle with another vehicle equipped with said front coupler and said rear coupler wherein
said vehicle includes a lateral location sensor in generally front end of said vehicle and at least one lateral location sensor guidance means in generally rear end of said vehicle.

2. A vehicle operated on highways as defined in claim 1 wherein
said vehicle includes a lateral position control means, and
said lateral position control means includes a motor that steers said vehicle.

3. A vehicle operated on highways as defined in claim 1 wherein
said vehicle includes a longitudinal sensor,
said vehicle includes a longitudinal position control means, and
said vehicle is able to couple and decouple with another one of said vehicle running in front of said vehicle while said vehicle is controlled by said lateral position control means and said longitudinal position control means.

4. A vehicle operated on highways as defined in claim 1 wherein
said front coupler couples with said rear coupler of a vehicle running in front of said vehicle using magnetic force.

5. A vehicle operated on highways as defined in claim 1 wherein
said front coupler couples with said rear coupler of a vehicle running in front of said vehicle using mechanical means.

6. A vehicle operated on highways as defined in claim 1 wherein
said vehicle has a different coupler height depending on vehicle type.

7. A vehicle operated on highways as defined in claim 1 wherein
said coupler includes a pair of snubber assembly each of which includes a coupling means with a contact surface and a snubber rod.

8. A vehicle operated on highways as defined in claim 7 wherein
said coupling means includes means to generate magnetic field,
two of said couplers couple together by magnetic attraction.

9. A vehicle operated on highways as defined in claim 7 wherein
said coupling means includes a suction cup, and
two of said couplers couple together by suction.

10. A vehicle operated on highways as defined in claim 1 wherein
said front coupler has a housing that encloses a coupling hook means and a coupling hook receiving bay disposed side by side, and
said rear coupler has a housing that encloses a coupling hook means and a coupling hook receiving bay disposed side by side.

11. A vehicle operated on highways as defined in claim 1 wherein said coupler has connection means for a communication cable.

12. A vehicle operated on highways including a front coupler and a rear coupler for physically coupling said vehicle with another vehicle equipped with said front coupler and said rear coupler wherein
said coupler absorbs at least some of longitudinal, lateral and vertical dislocations between coupled vehicles during normal driving within highway or street lane.

13. A vehicle operated on highways as defined in claim 12 wherein
said vehicle includes a lateral location sensor in generally front end and at least one lateral location sensor guidance means in generally rear end, and
said lateral location sensor is designed to estimate deviation of centerline of front end of said vehicle from center point of generally rear end of another one of said vehicle when said another one of said vehicle is running in front of said vehicle.

14. A vehicle operated on highways as defined in claim 12 wherein
said vehicle includes a lateral position control means, and
said lateral position control means includes a motor that steers said vehicle.

15. A vehicle operated on highways as defined in claim 12 wherein
said vehicle includes a longitudinal sensor,
said vehicle includes a longitudinal position control means, and
said vehicle is able to couple and decouple with another one of said vehicle running in front of said vehicle while said vehicle is controlled by said lateral position control means and said longitudinal position control means.

16. A vehicle operated on highways as defined in claim 12 wherein
said front coupler couples with said rear coupler of a vehicle running in front of said vehicle using magnetic force.

17. A vehicle operated on highways as defined in claim 12 wherein
said front coupler couples with said rear coupler of a vehicle running in front of said vehicle using mechanical means.

18. A vehicle operated on highways as defined in claim 12 wherein
said vehicle has a different coupler height depending on a vehicle type.

19. A vehicle operated on highways as defined in claim 12 wherein
said coupler includes a pair of snubber assembly.

20. A vehicle operated on highways as defined in claim 19 wherein
said coupler includes means to generate magnetic field,
two of said couplers couple together by magnetic attraction.
